(19) United States
(12) Patent Application Publication
(10) Pub. No.: US 2026/0094803 A1
(43) Pub. Date: Apr. 2, 2026

(54) APPARATUS FOR MANUFACTURING ELECTRODE AND METHOD FOR MANUFACTURING ELECTRODE

(71) Applicant: SK On Co., Ltd., Seoul (KR)

(72) Inventors: Min Chan KWON, Daejeon (KR); Yung Sup YOUN, Daejeon (KR)

(21) Appl. No.: 19/304,600

(22) Filed: Aug. 20, 2025

(30) Foreign Application Priority Data
Aug. 21, 2024 (KR) 10-2024-0111882

(51) Int. Cl. H01M 4/04

(52) U.S. Cl. CPC H01M 4/0435

(57) ABSTRACT

The present disclosure relates to an apparatus for manufacturing an electrode and a method for manufacturing an electrode. An electrode manufacturing apparatus according to one embodiment comprises: a dry electrode composition supply portion; a laminating portion; a first roller and a second roller configured to process the dry electrode composition supplied from the dry electrode composition supply portion into a dry electrode sheet while transferring it to the laminating portion; wherein the first roller and the second roller have different diameters from each other, and wherein, in the laminating portion, the dry electrode sheet can be laminated on a current collector supplied from the outside.

### CROSS-REFERENCE TO RELATED PATENT APPLICATION

The present application claims priority under 35 U.S.C. § 119(a) to Korean patent application number 10-2024-0111882 filed on Aug. 21, 2024, in the Korean Intellectual Property Office, the entire disclosure of which is incorporated by reference herein.

### BACKGROUND OF THE INVENTION

### 1. Field

The present disclosure relates to an apparatus for manufacturing an electrode and a method for manufacturing an electrode.

### 2. Description of the Related Art

As development of electric vehicles, energy storage batteries, robots, satellites, and the like accelerates, research on high-performance secondary batteries capable of repetitive charging and discharging (rechargeable) as energy sources is actively progressing.

Currently commercialized secondary batteries include nickel-cadmium batteries, nickel-metal hydride batteries, nickel-zinc batteries, and lithium secondary batteries. Among these, lithium secondary batteries (hereinafter, lithium-ion batteries or lithium batteries) have advantages over nickel-based secondary batteries in that they exhibit almost no memory effect, allow free charging and discharging, have very low self-discharge rates, and have high energy density.

Electrodes of conventional secondary batteries manufactured by wet processes are produced by coating and drying an electrode slurry in which active material, binder, and/or conductive agent are mixed in a solvent onto a current collector, followed by a pressing rolling process to control the density of the electrode.

The rolling process involves inserting an electrode to be rolled between rollers rotating in opposite directions, and increasing the electrode density by compressing the electrode through compressive force generated between the rotating rollers.

However, when coating both sides, there is a problem of difficulty in uniformly controlling the density on each side. When the active material is coated on the current collector and compressed, forces are generated in various directions; among these, shear force in the width direction can form wrinkles on the current collector adjacent to the coated portion, which can cause electrode defects.

Meanwhile, to improve problems of the conventional wet process, a dry electrode manufacturing process without using solvents has been proposed. However, the manufacturing process mainly adopted in the current dry process is a direct lamination (Direct lami) method that adjusts the electrode width by controlling the gap between rollers used in the process, but has a limitation in that it cannot control the gap and pressure generated during lamination because the pressure applied during lamination cannot be controlled.

### SUMMARY OF THE INVENTION

One of the various objectives of the present disclosure is to provide an apparatus for manufacturing an electrode and a method for manufacturing an electrode capable of uniformly controlling the density of the electrode.

One of the various objectives of the present disclosure is to provide an apparatus for manufacturing an electrode and a method for manufacturing an electrode capable of reducing the defect rate of the electrode.

One of the various objectives of the present disclosure is to provide an apparatus for manufacturing an electrode and a method for manufacturing an electrode capable of improving process efficiency.

An embodiment of the present disclosure may provide an apparatus for manufacturing an electrode may comprise: a dry electrode composition supply portion; a laminating portion; a first roller and a second roller configured to process the dry electrode composition supplied from the dry electrode composition supply portion into a dry electrode sheet while transferring it to the laminating portion; wherein the first roller and the second roller have different diameters from each other, and wherein, in the laminating portion, the dry electrode sheet is laminated on a current collector supplied from the outside.

In one example of the present disclosure, the diameter of the first roller of the electrode manufacturing apparatus may be larger than the diameter of the second roller.

In an embodiment of the present disclosure, the electrode manufacturing apparatus may include a plurality of at least one of the first roller and the second roller.

In one example, the electrode manufacturing apparatus according to the present disclosure may include at least one second roller disposed adjacent to the first roller, and a dry electrode composition or a dry electrode sheet may be supplied between the first roller and the second roller.

In another example, the electrode manufacturing apparatus according to the present disclosure may include at least one first roller disposed adjacent to the first roller, and a dry electrode composition or a dry electrode sheet may be supplied between the first roller and the first roller.

In another example, the electrode manufacturing apparatus according to the present disclosure may include at least one second roller disposed adjacent to the second roller, and a dry electrode composition or a dry electrode sheet may be supplied between the second roller and the second roller.

In yet another example, the electrode manufacturing apparatus according to the present disclosure may include at least one second roller disposed adjacent to the laminating portion, and the dry electrode sheet may be laminated on the current collector by the second roller.

In one example of the present disclosure, the electrode manufacturing apparatus may include a plurality of first rollers, a plurality of second rollers, and a plurality of dry electrode composition supply portions, wherein the plurality of first rollers, second rollers, and dry electrode composition supply portions are arranged to be symmetrical with respect to the laminating portion.

Another embodiment of the present disclosure may provide a method for manufacturing an electrode, comprising: a step of preparing a dry electrode composition;

a step of transferring the dry electrode composition in a predetermined direction while processing the dry electrode composition into a dry electrode sheet using an electrode manufacturing apparatus comprising a first roller and a second roller having different diameters; and a step of laminating the dry electrode sheet transferred through the first roller and the second roller onto a current collector.

In one example, the step of transferring in the electrode manufacturing method according to the present disclosure may include heating and pressing the dry electrode composition and the dry electrode sheet by the first roller and the second roller.

In one example of the electrode manufacturing method according to the present disclosure, the electrode manufacturing apparatus may include a plurality of first rollers, a plurality of second rollers, and a plurality of dry electrode composition supply portions, wherein the plurality of first rollers, second rollers, and dry electrode composition supply portions are arranged to be symmetrical with respect to the laminating portion, and wherein the step of laminating laminates the dry electrode sheet on both surfaces of the current collector.

In one embodiment of the electrode manufacturing method according to the present disclosure, the electrode manufacturing apparatus may include two second rollers adjacent to the current collector, and in the step of laminating, the dry electrode sheet supplied between the current collector and the two second rollers may be laminated onto the current collector.

One of the various effects of the present disclosure is to provide an apparatus for manufacturing an electrode and a method for manufacturing an electrode capable of uniformly controlling the density of the electrode.

One of the various effects of the present disclosure is to provide an apparatus for manufacturing an electrode and a method for manufacturing an electrode capable of reducing the defect rate of the electrode.

One of the various effects of the present disclosure is to provide an apparatus for manufacturing an electrode and a method for manufacturing an electrode capable of improving process efficiency.

The apparatus for manufacturing an electrode and the method for manufacturing an electrode according to the present disclosure can be widely applied in green technology fields such as electric vehicles, battery charging stations, and other battery-powered renewable energy sources such as solar power generation and wind power generation. In addition, the apparatus and method of the present disclosure can be used for eco-friendly electric vehicles and hybrid vehicles that suppress air pollution and greenhouse gas emissions to prevent climate change.

However, the various advantageous effects and benefits of the present disclosure are not limited to the above description, and will be more easily understood through the detailed description of specific embodiments of the present disclosure.

### BRIEF DESCRIPTION OF THE DRAWINGS

FIG. 1 is a schematic view illustrating an apparatus for manufacturing an electrode according to one example of the present disclosure.

FIG. 2 is an enlarged view of region A of FIG. 1.

FIG. 3 is a schematic diagram illustrating one modification of the electrode manufacturing apparatus of FIG. 1.

FIG. 4 is a schematic diagram illustrating another modification of the electrode manufacturing apparatus of FIG. 1.

FIG. 5 is a schematic view illustrating an apparatus for manufacturing an electrode according to another example of the present disclosure.

FIG. 6 is an enlarged view of region B of FIG. 5.

FIG. 7 is a schematic diagram illustrating one modification of the electrode manufacturing apparatus of FIG. 5.

FIG. 8 is a schematic diagram illustrating another modification of the electrode manufacturing apparatus of FIG. 5.

### DETAILED DESCRIPTION

Before describing the present disclosure in more detail, definitions of terms used in this specification are provided.

In this specification, expressions such as “have,” “may have,” “include,” or “may include” refer to the presence of the relevant features (e.g., numerical values, functions, operations, or components) and do not exclude the presence of additional features.

In this specification, expressions such as “A or B,” “at least one of A or/and B,” or “one or more of A or/and B” may include all possible combinations of the listed items. For example, “A or B,” “at least one of A and B,” or “at least one of A or B” may refer to (1) including at least one A, (2) including at least one B, or (3) including both at least one A and at least one B.

In this specification, the term “battery” may be used interchangeably with “cell,” and the battery or cell may collectively refer to battery cells as units thereof, battery modules, or battery packs including the battery cells.

In the present disclosure, the term “electrode” may encompass both positive electrodes and negative electrodes. The term “current collector” may encompass both positive electrode current collectors and negative electrode current collectors. Also, the term “active material layer” may encompass both positive electrode active material layers and negative electrode active material layers. Similarly, the term “active material” may encompass both positive electrode active materials and negative electrode active materials. Furthermore, the term “tab” may encompass both positive electrode tabs and negative electrode tabs.

In the drawings, the X direction may be defined as the first direction, the L direction, or the longitudinal direction; the Y direction as the second direction, the W direction, or the width direction; and the Z direction as the third direction, the T direction, or the thickness direction.

Hereinafter, embodiments of the present invention will be described with reference to specific embodiments and the accompanying drawings. This is not intended to limit the technology described in this specification to particular embodiments but should be understood to include various modifications, equivalents, and/or alternatives of the embodiments of the present invention.

Regarding the description of the drawings, similar reference numerals may be used for similar components. Also, to clearly explain the present invention in the drawings, portions unrelated to the description are omitted, thicknesses are exaggerated to clearly express multiple layers and regions, and functions of components within the scope of the same concept may be described using the same reference numerals.

The present disclosure relates to an apparatus for manufacturing an electrode. An electrode manufacturing apparatus according to one embodiment of the present disclosure may comprise: a dry electrode composition supply portion 101; a laminating portion 121; a first roller 111 configured to process the dry electrode composition supplied from the dry electrode composition supply portion 101 into a dry electrode sheet 102 while transferring it to the laminating portion 121; and a second roller 112; wherein the first roller 111 and the second roller 112 have different diameters from each other, and wherein, in the laminating portion 121, the dry electrode sheet 102 can be laminated onto a current collector 201 supplied from the outside.

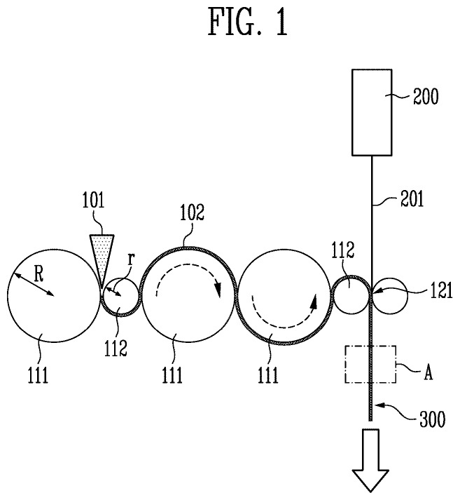

FIG. 1 is a schematic view illustrating an apparatus for manufacturing an electrode according to one example of the present disclosure. Referring to FIG. 1, the apparatus for manufacturing an electrode according to the present disclosure may include a dry electrode composition supply portion 101, a first roller 111, a second roller 112, and a laminating portion 121. In this case, the first roller 111 and the second roller 112 may process the dry electrode composition supplied from the dry electrode composition supply portion 101 into a dry electrode sheet 102 while transferring it to the laminating portion 121. As described below, the dry electrode composition and/or the dry electrode sheet 102 may be heated and/or pressed while being transferred through the first roller 111 and/or the second roller 112. The heated and/or pressed dry electrode composition may be processed into the dry electrode sheet 102, and the heated and/or pressed dry electrode sheet 102 may be coated on a current collector 201 in the laminating portion 121.

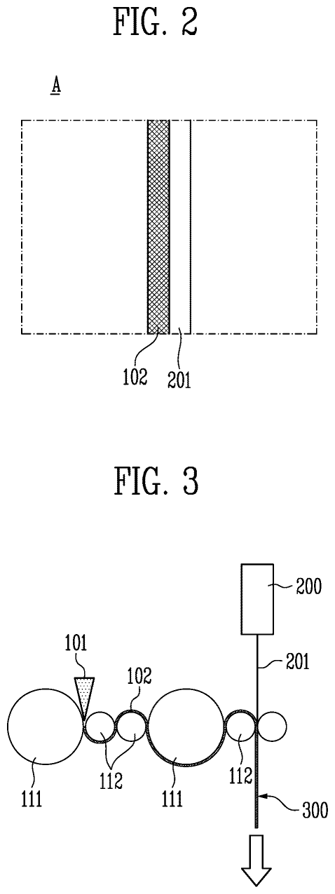

FIG. 2 is an enlarged view of region A of FIG. 1. Referring to FIGS. 1 and 2, the dry electrode sheet 102 is transferred to the laminating portion 121 by the first roller 111 and the second roller 112, and the dry electrode sheet 102 may be coated on a current collector 201 supplied from the outside at the laminating portion. The current collector 201 may be supplied from a current collector supply portion 200, but is not limited thereto. At the laminating portion 121, an electrode 300 in which the dry electrode sheet 102 is laminated on at least one surface of the current collector 201 is manufactured and may be continuously discharged.

Electrodes of secondary batteries manufactured by conventional wet processes are produced by coating and drying an active material slurry on a current collector, followed by pressing. Generally, the pressing is performed through rolling, but when rolling the electrode using a pair of rotating rollers, variations in the pressure applied to the electrode occur, causing difficulty in uniformly controlling the density. Additionally, shear forces generated in the width direction of the electrode during rolling can form wrinkles on the current collector, increasing the defect rate of the electrode. In contrast, the electrode manufacturing apparatus according to the present disclosure is a dry electrode manufacturing apparatus manufactured by a dry process, comprising a first roller 111 and a second roller 112 having different diameters from each other, wherein a dry electrode sheet 102 processed and transferred in a sheet form through the first roller 111 and the second roller 112 is laminated on a current collector 201, thereby enabling the manufacture of electrodes with uniform density.

The electrode may be an electrode for a secondary battery (including an all-solid-state battery). Referring to FIGS. 1 and 2, the dry electrode sheet 102 may be laminated on a current collector 201 at the laminating portion 121 of the electrode manufacturing apparatus according to the present disclosure, and as the dry electrode sheet 102 passes through the laminating portion 121, an electrode 300 with the dry electrode sheet laminated thereon may be manufactured.

The current collector is not particularly limited in type, size, or shape, as long as it has conductivity without causing chemical changes in the battery. For example, the current collector may be made of stainless steel, aluminum, nickel, titanium, graphitized carbon, or may be surface-treated with carbon, nickel, titanium, or silver on aluminum or stainless steel.

The dry electrode composition may include an electrode active material and a binder.

In one embodiment, the electrode active material may be a positive electrode active material or a negative electrode active material.

According to an exemplary embodiment, the positive electrode active material may include a compound capable of reversibly intercalating and deintercalating lithium ions.

According to an exemplary embodiment, the positive electrode active material may include a lithium-transition metal composite oxide. In one example, the positive electrode active material may include a lithium-nickel metal composite oxide. The lithium-nickel metal composite oxide may further include at least one of cobalt (Co), manganese (Mn), and aluminum (AI).

In some embodiments, the positive electrode active material or the lithium-nickel metal composite oxide may include a layered structure or a crystal structure represented by the following Chemical Formula 1.

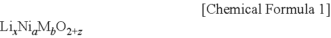

In Chemical Formula 1, 0.9≤x≤1.2, 0.6≤a≤0.99, 0.01≤b≤0.4, and −0.5≤z≤0.1. As described above, M may include Co, Mn, and/or Al.

In one embodiment, in Chemical Formula 1, a may be in the range of 0.8 to 0.95. When a satisfies the above numerical range, the manufactured lithium secondary battery can realize a high-capacity characteristic.

The chemical structure represented by Chemical Formula 1 indicates bonding relationships included within the layered structure or crystal structure of the positive electrode active material and does not exclude other additional elements. For example, M may include Co and/or Mn, and Co and/or Mn may serve as main active elements together with Ni in the positive electrode active material. Chemical Formula 1 is provided to represent the bonding relationships of the main active elements and should be understood to encompass introduction and substitution of additional elements.

Alternatively, the lithium-transition metal composite oxide may refer to composite oxides of forms other than lithium-nickel metal composite oxides. For example, it may refer to lithium iron phosphate (LFP)-based oxides represented by the chemical formula LiFePO₄ or lithium cobalt (LCO)-based oxides represented by the chemical formula LiCoO₂.

According to an exemplary embodiment, the negative electrode active material may include a compound capable of reversibly intercalating and deintercalating lithium ions.

For example, the negative electrode active material may include a carbon-based active material comprising carbon-based materials such as crystalline carbon, amorphous carbon, carbon composites, and carbon fibers; a metal-based active material including lithium metal or lithium alloys; a silicon-based active material including silicon (Si)-containing materials; or tin (Sn)-containing materials.

Examples of the amorphous carbon include hard carbon, soft carbon, coke, mesocarbon microbeads (MCMB), and mesophase pitch-based carbon fibers (MPCF).

Examples of the crystalline carbon include graphite-based carbons such as natural graphite, artificial graphite, graphitized coke, graphitized MCMB, and graphitized MPCF.

The silicon-based active material can provide increased capacity characteristics. The silicon-based active material may be Si, SiOₓ (0<x≤2), Si-Q alloy (where Q is an element selected from the group consisting of alkali metals, alkaline earth metals, group 13 elements, group 14 elements, group 15 elements, group 16 elements, transition metals, rare earth elements, and combinations thereof, excluding Si), Si-carbon composites, or a mixture of at least one of these with SiO₂.

In one embodiment, the binder may refer to a fiber-formable binder. Examples thereof may include polytetrafluoroethylene, polyethylene oxide, polyvinylpyrrolidone, polyvinyl alcohol, and cellulose derivatives.

In an exemplary embodiment, the binder may have a particulate form in which fine fibers are bundled together to form a cluster. In this case, by heating and/or pressing at a predetermined temperature or pressure, the bundled fibers may be disentangled, enabling binding between adjacent objects.

In an exemplary embodiment, the binder may further include a particulate binder along with the fiber-formable binder. The particulate binder may be one commonly used in electrode manufacturing, for example, polyvinylidene fluoride, polyvinylidene fluoride-hexafluoropropylene, polyvinylidene fluoride-trichloroethylene, polymethyl methacrylate, polyacrylonitrile, polyvinyl acetate, ethylene-vinyl acetate copolymer, cyanoethyl pullulan, or pullulan.

In an exemplary embodiment, the dry electrode composition may further include a conductive agent to improve conductivity as needed. The conductive agent may be any commonly used material in secondary batteries without limitation, for example, one or more selected from the group consisting of graphite such as natural graphite or artificial graphite, carbon black, acetylene black, ketjen black, carbon fibers, carbon nanotubes, metal powders or metal fibers such as copper, nickel, aluminum, silver, and conductive polymers such as conductive oxides or polypyrrole derivatives.

In one embodiment, the electrode active material and the binder may each be provided in particulate form, and accordingly, the dry electrode composition may be provided as a mixture of the respective particles; however, it is not necessarily limited thereto and may be provided in various forms such as a single particle assembly having a core-shell structure as needed.

In one example of the present disclosure, the diameter of the first roller 111 of the electrode manufacturing apparatus may be larger than the diameter of the second roller 112. Referring to FIG. 1, when the diameter of the first roller 111 is denoted as R and the diameter of the second roller 112 is denoted as r, the relationship R >r may be satisfied.

As will be described below, during the calendaring process of the dry electrode sheet, the roller with the smaller diameter can apply higher pressure per unit contact area compared to the roller with the larger diameter, thereby applying higher pressure to the contacted member (in the present disclosure, the dry electrode composition or the dry electrode sheet). Meanwhile, due to the relationship defined by the following relational expression, the roller with the larger diameter may have a higher thermal conductivity to the contacted member than the roller with the smaller diameter.

$$[ relational expression ]$$

$$P = K * A ( Δ T / L )$$

In the above relational expression, P denotes heat flux (W), A denotes the area of the member (m²), L denotes the thickness of the member (m), and ΔT denotes the temperature difference (° C.) between the roller and the sample.

In one example, the ratio (r/R) of the diameter r of the second roller 112 to the diameter R of the first roller 111 in the electrode manufacturing apparatus according to the present disclosure may be 0.7 or less. The ratio (r/R) of the diameter r of the second roller 112 to the diameter R of the first roller 111 may be 0.7 or less, 0.5 or less, 0.3 or less, 0.25 or less, 0.2 or less, or 0.19 or less, but is not limited thereto. The lower limit of the ratio (r/R) of the diameter r of the second roller 112 to the diameter R of the first roller 111 is not particularly limited but may be, for example, 0.15 or more. That is, in one example, the diameter r of the second roller 112 may be 0.15 times or more and 0.7 times or less of the diameter R of the first roller 111. When the ratio of the diameter R of the first roller 111 to the diameter r of the second roller 112 in the electrode manufacturing apparatus according to the present disclosure satisfies the above range, the defect rate of the manufactured electrode can be further reduced.

The diameters R and r of the first roller 111 and the second roller 112, respectively, in the electrode manufacturing apparatus according to the present disclosure are not particularly limited as long as they satisfy the aforementioned ratio. The diameter R of the first roller 111 and the diameter r of the second roller 112 may each be within a range of 5 mm or more and/or 10,000 mm or less, but are not limited thereto. In one embodiment of the present disclosure, the first roller 111 and/or the second roller 112 may heat a member existing on or between the rollers, and simultaneously or separately apply pressure to the member existing between the rollers. In one embodiment, the first roller 111 and/or the second roller 112 may heat the member on or between the rollers to a temperature of 80° C. to 200° C.

In an exemplary embodiment, the first roller 111 and/or the second roller 112 may include a heating element. The type of the heating element is not particularly limited as long as it can heat the roller. The heating element may be a cartridge heater, a heating element using hot oil or induction heating, but is not limited thereto. The material of the heating element is also not particularly limited as long as it can heat the roller, and may include one or more metals selected from the group consisting of nickel (Ni), tungsten (W), molybdenum (Mo), manganese (Mn), copper (Cu), silver (Ag), gold (Au), niobium (Nb), titanium (Ti), palladium (Pd), platinum (Pt), or their alloys, but is not limited thereto. In the above embodiment, the surface temperature of the first roller 111 and/or the second roller 112 may increase due to heat supplied from the heating element, thereby heating the dry electrode composition or the dry electrode sheet 102 in contact with the surface of the first roller 111 and/or the second roller 112. In conventional wet processes, when heating the electrode slurry, heat sources such as hot air, steam, infrared (IR) lamps, or VECSEL devices were used. However, when using such heat sources, the solvent evaporates first during heating, causing drying to proceed from the surface of the slurry, followed by drying inside the slurry through heat transfer. This process can cause over-drying of the slurry surface or insufficient drying inside. The electrode manufacturing apparatus according to the present embodiment can more effectively calendar the dry electrode composition or the dry electrode sheet 102 by heating the first roller 111 and/or the second roller 112 that are in direct contact with the dry electrode composition or the dry electrode sheet 102, and can more effectively laminate the dry electrode sheet 102 onto the current collector 201 described below.

In one embodiment of the present disclosure, the electrode manufacturing apparatus may include a plurality of the first rollers 111 and/or a plurality of the second rollers 112. The electrode manufacturing apparatus according to the present disclosure including a plurality of the first rollers 111 and/or the second rollers 112 means that the apparatus may include multiple first rollers 111, multiple second rollers 112, or multiple first rollers 111 and multiple second rollers 112.

When the electrode manufacturing apparatus according to the present disclosure includes a plurality of the first rollers 111 and/or the second rollers 112, processing using the first rollers 111 and/or the second rollers 112 may be performed multiple times. For example, the dry electrode composition may be calendared and processed into a dry electrode sheet 102 between adjacent rollers, and during this process, the dry electrode sheet 102 may be heated and/or pressed multiple times by the multiple rollers. Meanwhile, the temperature and pressure applied to the dry electrode composition and/or the dry electrode sheet 102 in each heating and/or pressing process may differ as needed. Details thereof will be described below.

In one embodiment, the electrode manufacturing apparatus according to the present disclosure may include at least one first roller disposed adjacent to the first roller, and a dry electrode composition or a dry electrode sheet may be supplied between the first roller and the first roller.

Referring to FIG. 1, the dry electrode composition supplied from the dry electrode composition supply portion 101 of the electrode manufacturing apparatus of FIG. 1 is introduced between the first roller 111 and the second roller 112, and while sequentially passing through the first roller 111, the first roller 111, and the second roller 112, it is processed into a dry electrode sheet 102 and supplied to the laminating portion 121. At this time, the dry electrode composition supplied from the dry electrode composition supply portion 101 may be supplied between the second roller 112 and the first roller 111, and may be heated and/or pressed between the first roller 111 and the second roller 112 to be processed into a sheet form. Meanwhile, the thickness of the finally manufactured dry electrode sheet 102 may be determined during this process. Further, the dry electrode sheet 102 processed into a sheet form as described above may be supplied between the first roller 111 and the first roller 111, and between the first roller 111 and the second roller 112 prior to being supplied to the laminating portion 121, so that it can be calendared as described below. When the electrode manufacturing apparatus according to the present disclosure includes a second roller 112 adjacent to the first roller 111 and the dry electrode composition is supplied between the first roller 111 and the second roller 112, the pressure applied to the dry electrode composition can increase due to the presence of the smaller diameter second roller 112, enabling achievement of a thin electrode thickness with fewer rollers as described above.

In another example, the electrode manufacturing apparatus according to the present disclosure may include at least one first roller 111 disposed adjacent to the first roller 111, and the dry electrode composition or the dry electrode sheet 102 may be supplied between the first roller 111 and the first roller 111. Referring again to FIG. 1, the dry electrode composition supplied from the dry electrode composition supply portion 101 may sequentially pass through the first roller 111, the first roller 111, and the second roller 112 to be supplied to the laminating portion 121. At this time, the dry electrode sheet 102 processed into a sheet form as described above and supplied from the dry electrode composition supply portion 101 may be supplied between two first rollers 111. When the dry electrode sheet 102 is supplied between two first rollers 111 as in the above example, both surfaces of the dry electrode sheet 102 can be pressed and heated simultaneously, and as described above, the dry electrode sheet 102 passes through the first rollers 111 having a large diameter, allowing smooth heat transfer to the dry electrode sheet 102. The calendaring can be smoothly performed. Through this, effective calendaring is possible, improving the manufacturing efficiency of the dry electrode.

In yet another example, the electrode manufacturing apparatus according to the present disclosure may include at least one second roller 112 disposed adjacent to the second roller 112, and the dry electrode composition or the dry electrode sheet 102 may be supplied between the second roller 112 and the second roller 112.

FIG. 3 is a schematic diagram illustrating one modification of the electrode manufacturing apparatus of FIG. 1. Referring to FIG. 3, the dry electrode composition supplied from the dry electrode composition supply portion 101 of the electrode manufacturing apparatus of FIG. 3 is introduced between the first roller 111 and the second roller 112, and sequentially passes through the second roller 112, the first roller 111, and the second roller 112 to be supplied to the laminating portion 121. At this time, the dry electrode sheet 102 may be supplied between two second rollers 112. The supplied dry electrode sheet 102 may be pressed by the two second rollers 112. When the dry electrode sheet 102 is supplied between two second rollers 112 as in this example, the dry electrode sheet 102 can be pressed at a higher pressure by the two rollers, thereby increasing the compaction density of the dry electrode sheet 102 and eliminating the need for an additional pressing process for electrode manufacturing. Through this, the electrode manufacturing apparatus according to the present disclosure can manufacture a high-quality electrode.

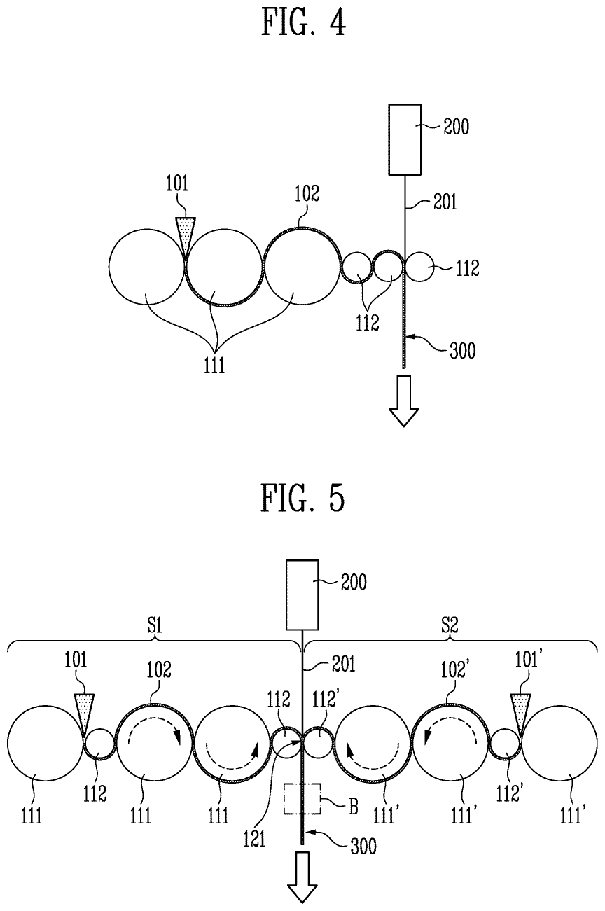

In another example, the electrode manufacturing apparatus according to the present disclosure may include at least one first roller 111 disposed adjacent to another first roller 111, and at least one second roller 112 disposed adjacent to another second roller 112. FIG. 4 is a schematic diagram illustrating another modification of the electrode manufacturing apparatus of FIG. 1. Referring to FIG. 4, the dry electrode composition supplied from the dry electrode composition supply portion 101 of the electrode manufacturing apparatus according to this example is introduced between the first rollers 111, and sequentially passes through the first roller 111, the second roller 112, and the second roller 112 to be supplied to the laminating portion 121. As in this example, the electrode can be manufactured by processing the dry electrode sheet 102 in one process while forming the electrode to a desired thickness.

In one embodiment of the present disclosure, the electrode manufacturing apparatus may include at least one second roller 112 disposed adjacent to the laminating portion 121, wherein the dry electrode sheet 102 may be laminated on the current collector 201 by the second roller 112. When the electrode manufacturing apparatus includes one or more second rollers 112 disposed adjacent to the laminating portion 121 as in this embodiment, at least one of the rollers arranged in the laminating portion 121 may be the second roller 112. By arranging two rollers in the laminating portion 121 to include at least one second roller 112, the dry electrode sheet 102 can be laminated on the current collector 201 by the second roller 112. Through this, the dry electrode sheet 102 can be smoothly laminated on the current collector 201 in a series of processes without a separate pressing process or pressing means.

In one example of the present disclosure, the electrode manufacturing apparatus according to the present disclosure may include a plurality of first rollers 111, a plurality of second rollers 112, and a plurality of dry electrode composition supply portions 101. The electrode manufacturing apparatus including a plurality of first rollers 111, second rollers 112, and dry electrode composition supply portions 101 means that the apparatus may include multiple first rollers 111, multiple second rollers 112, and multiple dry electrode composition supply portions 101.

In this case, the plurality of first rollers 111, second rollers 112, and dry electrode composition supply portions 101 may be arranged to be symmetrical with respect to the laminating portion 121.

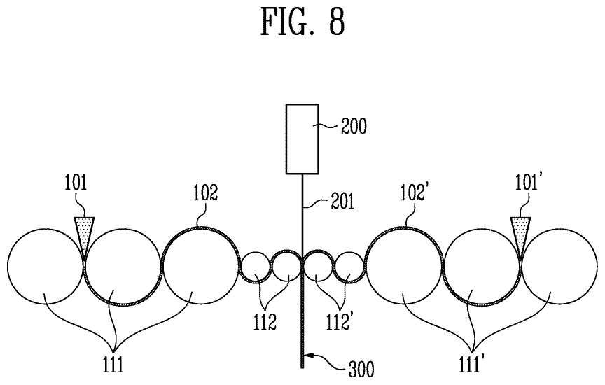

FIG. 5 is a schematic view illustrating an apparatus for manufacturing an electrode according to another example of the present disclosure. FIG. 7 is a schematic diagram illustrating one modification of the electrode manufacturing apparatus of FIG. 5. FIG. 8 is a schematic diagram illustrating another modification of the electrode manufacturing apparatus of FIG. 5. Referring to FIGS. 5 to 8, a first set S1 including a first roller 111, a second roller 112, and a dry electrode composition supply portion 101 may be arranged on one side with respect to the laminating portion 121, and a second set S2 including a first roller 111′, a second roller 112′, and a dry electrode composition supply portion 101′ may be arranged on the other side with respect to the laminating portion 121.

In the above example, the first set S1 and the second set S2 may have the same configuration. Having the same configuration means that the number of first rollers 111, second rollers 112, and dry electrode composition supply portions 101 in the first set S1 is equal to the number of first rollers 111′, second rollers 112′, and dry electrode composition supply portions 101′ in the second set S2. In addition, the first set S1 and the second set S2 may have a structure symmetrical with respect to the laminating portion 121. Having a symmetrical structure means that the first rollers 111, second rollers 112, and dry electrode composition supply portions 101 of the first set S1 are arranged symmetrically with the first rollers 111′, second rollers 112′, and dry electrode composition supply portions 101′ of the second set S2 with respect to the laminating portion 121.

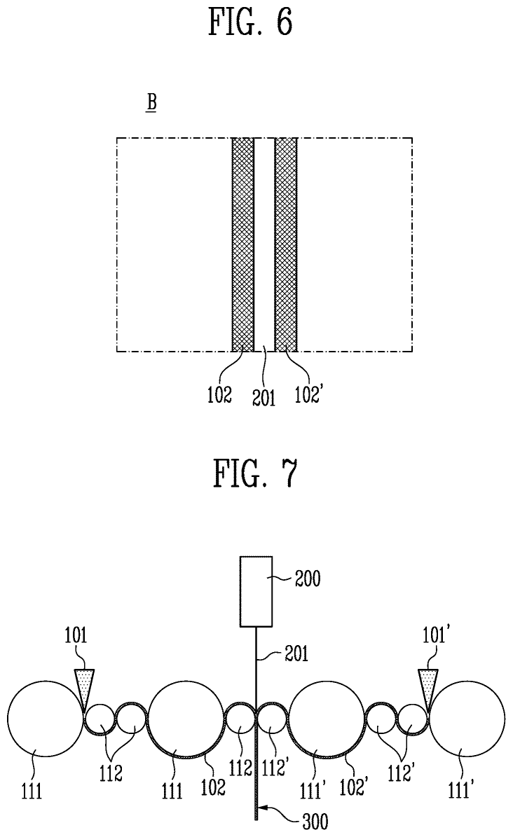

When a plurality of first rollers 111, second rollers 112, and dry electrode composition supply portions 101 of the electrode manufacturing apparatus are arranged symmetrically with respect to the laminating portion 121 as in this example, an electrode with dry electrode sheets 102 and 102′ laminated on both surfaces of the current collector 201 can be manufactured. FIG. 6 is an enlarged view of region B of FIG. 5. Referring to FIGS. 5 and 6, the dry electrode sheet 102 supplied from the first set S1 and the dry electrode sheet 102′ supplied from the second set S2 are each supplied to the laminating portion 121 and laminated on both surfaces of the current collector 201, respectively. Through this, the electrode manufacturing apparatus according to this example can simplify the process equipment and reduce manufacturing time in producing double-sided laminated electrodes.

The present disclosure also relates to a method for manufacturing an electrode. A method for manufacturing an electrode according to one embodiment of the present disclosure may comprise: a step of preparing a dry electrode composition; a step of processing the dry electrode composition into a dry electrode sheet 102 and transferring it in a predetermined direction using an electrode manufacturing apparatus comprising a first roller 111 and a second roller 112 having a diameter different from that of the first roller 111; and a step of laminating the dry electrode sheet 102 transferred through the first roller 111 and the second roller 112 onto a current collector 201.

The dry electrode composition may include an electrode active material and a binder as described above. The step of preparing the dry electrode composition may be a step of preparing a dry electrode composition including an electrode active material and a binder. For example, the step may mean preparing a dry electrode composition in the form of a mixture by mixing particulate electrode active material and binder in a predetermined ratio, however, the step is not necessarily limited thereto.

The step of processing and transferring the dry electrode composition into a dry electrode sheet (102) may involve using the aforementioned electrode manufacturing apparatus to process and transfer the sheet. The electrode manufacturing apparatus may be configured such that the dry electrode composition is supplied from the dry electrode composition supply portion 101, and the dry electrode composition is processed into the dry electrode sheet 102 by using a first roller 111 and a second roller 112 having a diameter different from that of the first roller 111, while being transferred in a direction toward the laminating portion 121 of the aforementioned electrode manufacturing apparatus. In the step of transferring the dry electrode sheet 102 using the first roller 111 and the second roller 112 having a diameter different from that of the first roller 111, the dry electrode sheet 102 may be transferred along the surface of the first roller 111, or along the surface of the second roller 112, or along the surfaces of both the first roller 111 and the second roller 112. When the dry electrode sheet 102 is transferred along the surface of the first roller 111 and/or the second roller 112, the dry electrode sheet 102 may be in contact with the surface of the first roller 111 and/or the second roller 112 while being transferred.

In one example of the present disclosure, the diameter of the first roller 111 may be larger than the diameter of the second roller 112.

Meanwhile, in one example of the present disclosure, the ratio (r/R) of the diameter r of the second roller 112 to the diameter R of the first roller 111 may be 0.7 or less. The ratio (r/R) of the diameter r of the second roller 112 to the diameter R of the first roller 111 may be 0.7 or less, 0.5 or less, 0.3 or less, 0.25 or less, 0.2 or less, or 0.19 or less, but the present disclosure is not limited thereto. The lower limit of the ratio (r/R) of the diameter r of the second roller 112 to the diameter R of the first roller 111 is not particularly limited but may be, for example, 0.15 or more. That is, in one example, the diameter r of the second roller 112 may be 0.15 times or more and 0.7 times or less of the diameter R of the first roller 111. Other matters related to the first roller 111 and the second roller 112 are as described above with reference to FIG. 1, and thus duplicate explanations are omitted hereinafter. In one example, the step of transferring the electrode manufacturing method according to the present disclosure may include a step in which the dry electrode composition and the dry electrode sheet 102 are heated and pressed by the first roller 111 and the second roller 112.

Heating by the first roller 111 and/or the second roller 112 may be performed simultaneously while the first roller 111 and/or the second roller 112 rotate, and may be continuously performed as the dry electrode composition and/or the dry electrode sheet 102 are transferred along the surfaces of the first roller 111 and/or the second roller 112. The heating may be performed up to a temperature necessary for calendaring the dry electrode composition and/or the dry electrode sheet 102, and the temperature necessary for calendaring may be a temperature at which the binder included in the dry electrode composition can be fibrillated, for example, within a range of 150° C. or higher and/or 200° C. or lower, but is not limited thereto.

Meanwhile, pressing by the first roller 111 and/or the second roller 112 may be performed simultaneously while the first roller 111 and/or the second roller 112 rotate, and may be continuously performed as the dry electrode composition and/or the dry electrode sheet 102 are transferred along the surfaces of the first roller 111 and/or the second roller 112. In the step of pressing performed by the first roller 111 and the second roller 112, the thickness of the manufactured dry electrode sheet 102 may be adjusted to a desired range. In addition, by pressing the dry electrode sheet 102 with the second roller 112, the manufactured electrode may have a high compaction density.

In one embodiment of the present disclosure, the electrode manufacturing apparatus of the electrode manufacturing method according to the present disclosure may include a plurality of first rollers 111, a plurality of second rollers 112, and a plurality of dry electrode composition supply portions 101, wherein the plurality of first rollers 111, second rollers 112, and dry electrode composition supply portions 101 may be arranged to be symmetrical with respect to the laminating portion 121.

At this time, in the step of laminating the dry electrode sheet 102 transferred through the first rollers 111 and second rollers 112 onto the current collector 201, the dry electrode sheets 102 may be laminated on both surfaces of the current collector 201. The electrode manufacturing method according to this embodiment may be performed using the aforementioned electrode manufacturing apparatus, in which the plurality of first rollers 111, second rollers 112, and dry electrode composition supply portions 101 are arranged to be symmetrical with respect to the laminating portion 121. As described above, the electrode manufacturing apparatus may include a first set S1 and a second set S2, each including the first rollers 111, second rollers 112, and dry electrode composition supply portions 101, wherein the first set S1 and the second set S2 have the same configuration and are arranged symmetrically with respect to the laminating portion 121. The electrode manufacturing method according to this embodiment may laminate the dry electrode sheets 102 supplied from the first set S1 and the second set S2 arranged symmetrically on both surfaces of the current collector 201.

In one example of the present disclosure, the electrode manufacturing apparatus of the electrode manufacturing method according to the present disclosure includes two second rollers 112 adjacent to the current collector 201, and in the step of laminating, the dry electrode sheet 102 supplied between the current collector 201 and the two second rollers 112 may be laminated onto the current collector 201. The electrode manufacturing method of this example laminates the dry electrode sheet 102 onto the current collector 201 using the two second rollers 112, thereby enabling smooth lamination of the dry electrode sheet 102 onto the current collector 201 in a series of processes without a separate pressing step or pressing means. Accordingly, the process equipment can be simplified and the manufacturing time can be reduced.

Although the embodiments of the present invention have been described in detail above, the present invention is not limited to the above embodiments and the accompanying drawings, and is intended to be limited only by the appended claims. Accordingly, various substitutions, modifications, and changes may be made by those skilled in the art without departing from the technical spirit of the invention as set forth in the claims, and such substitutions, modifications, and changes are also within the scope of the present invention.

What is claimed is:

1. An apparatus for manufacturing an electrode comprise:
a dry electrode composition supply portion;
a laminating portion; and
a first roller and a second roller configured to process a dry electrode composition supplied from the dry electrode composition supply portion into a dry electrode sheet while transferring the dry electrode composition to the laminating portion;
wherein the first roller and the second roller have different diameters from each other,
wherein, in the laminating portion, the dry electrode sheet is laminated on a current collector supplied from the outside.

2. The apparatus for manufacturing an electrode according to claim 1, wherein the diameter of the first roller is larger than the diameter of the second roller.

3. The apparatus for manufacturing an electrode according to claim 2, wherein the diameter of the second roller is 0.15 times or more and 0.7 times or less than the diameter of the first roller.

4. The apparatus for manufacturing an electrode according to claim 1, comprising a plurality of at least one of the first roller and the second roller.

5. The apparatus for manufacturing an electrode according to claim 1, comprising at least one second roller disposed adjacent to the first roller,
wherein a dry electrode composition or a dry electrode sheet is supplied between the first roller and the second roller.

6. The apparatus for manufacturing an electrode according to claim 1, comprising at least one first roller disposed adjacent to the first roller,
wherein a dry electrode composition or a dry electrode sheet is supplied between the first roller and the first roller.

7. The apparatus for manufacturing an electrode according to claim 1, comprising at least one second roller disposed adjacent to the second roller,
wherein a dry electrode composition or a dry electrode sheet is supplied between the second roller and the second roller.

8. The apparatus for manufacturing an electrode according to claim 1, comprising at least one second roller disposed adjacent to the laminating portion,
wherein the dry electrode sheet is laminated on the current collector by the second roller.

9. The apparatus for manufacturing an electrode according to claim 1, comprising a plurality of the first rollers, a plurality of the second rollers, and a plurality of the dry electrode composition supply portions,
wherein the plurality of first rollers, second rollers, and dry electrode composition supply portions are arranged to be symmetrical with respect to the laminating portion.

10. A method for manufacturing an electrode, comprising:
a step preparing of a dry electrode composition;
a step of transferring the dry electrode composition in a predetermined direction while processing the dry electrode composition into a dry electrode sheet using an electrode manufacturing apparatus comprising a first roller and a second roller having different diameters; and
a step of laminating the dry electrode sheet, which
h has been transferred through the first roller and the second roller, onto a current collector.

11. The method for manufacturing an electrode according to claim 10, wherein the diameter of the first roller is larger than the diameter of the second roller.

12. The method for manufacturing an electrode according to claim 11, wherein the diameter of the second roller is 0.15 times or more and 0.7 times or less than the diameter of the first roller.

13. The method for manufacturing an electrode according to claim 10, wherein the step transferring comprises heating and pressing the dry electrode composition and the dry electrode sheet by the first roller and the second roller.

14. The method for manufacturing an electrode according to claim 10, wherein the electrode manufacturing apparatus comprises a plurality of first rollers, a plurality of second rollers, and a plurality of dry electrode composition supply portions, and the plurality of first rollers, second rollers, and dry electrode composition supply portions are arranged to be symmetrical with respect to the laminating portion,
wherein the step of laminating laminates the dry electrode sheet on both surfaces of the current collector.

15. The method for manufacturing an electrode according to claim 10, wherein the electrode manufacturing apparatus includes two second rollers adjacent to the current collector,
wherein, in the step of laminating, the dry electrode sheet supplied between the current collector and the two second rollers is laminated onto the current collector.
